(19) United States
(12) Patent Application Publication
(10) Pub. No.: US 2013/0124162 A1
(43) Pub. Date: May 16, 2013

(54) METHOD OF CALCULATING A SHAPE FACTOR OF A DUAL MEDIA FRACTURED RESERVOIR MODEL FROM INTENSITIES AND ORIENTATIONS OF FRACTURE SETS FOR ENHANCING THE RECOVERY OF HYDROCARBINS

(71) Applicant: CONOCOPHILLIPS COMPANY, Houston, TX (US)

(72) Inventors: Lin Ying HU, Katy, TX (US); Patricia F. ALLWARDT, Houston, TX (US); Jason A. MCLENNAN, Anchorage, AK (US)

(73) Assignee: CONOCOPHILLIPS COMPANY, Houston, TX (US)

(21) Appl. No.: 13/655,496

(22) Filed: Oct. 19, 2012

Related U.S. Application Data
(60) Provisional application No. 61/560,534, filed on Nov. 16, 2011.

(51) Int. Cl. G06F 17/10

(52) U.S. Cl. 703/2

(57) ABSTRACT

A method of calculating a shape factor may include identifying a first fracture set, a second fracture set and a third fracture set within a subterranean formation; determining the azimuth and the dip of the first fracture set; determining the azimuth and the dip of the second fracture set; determining the azimuth and the dip of the third fracture set; determining the fracture spacing intensity of each fracture set, measuring an angle formed by an intersection of the first and second fracture sets; measuring an angle formed by an intersection of the first and third fracture sets; measuring an angle formed by an intersection of the second and third fracture sets; calculating a shape factor for each particular configuration of the plurality of fracture sets; and developing an ellipse-based equation utilizing the shape factors of these particular configurations and angles formed between each pair of the plurality of fracture sets.

### CROSS-REFERENCE TO RELATED APPLICATIONS

This application is a non-provisional application which claims benefit under 35 USC §119(e) to U.S. Provisional Application Ser. No. 61/560,534 filed Nov. 16, 2011, entitled “Method Of Calculating A Shape Factor Of A Dual Media Fractured Reservoir Model From Intensities And Orientations Of Fracture Sets For Enhancing The Recovery Of Hydrocarbons,” which is incorporated herein in its entirety.

### STATEMENT REGARDING FEDERALLY SPONSORED RESEARCH

None.

### FIELD

This invention relates to a method of calculating a shape factor of a dual media fractured reservoir model from intensities and orientations of fracture sets.

### BACKGROUND

Computer-based models of anticipated fluid flow through subterranean formations/reservoirs may be utilized to enhance recovery of hydrocarbons, such as oil and natural gas. Most subterranean hydrocarbon reservoirs are fractured. Computer models of fractured reservoirs may account for various geological parameters such as the number of fracture sets through a subterranean rock formation, the intensity and orientation of the fracture sets, and the length and aperture of the fracture sets. Each geological parameter may contribute to the fluid transfer rate through a given subterranean formation. The influence of these geological parameters to the fluid transfer may be determined by building an explicit discrete fracture network (DFN), then by performing fluid flow simulation. However, creating and utilizing a computer model of a full field DFN with thousands or even millions of fractures is extremely computation/human time consuming. This is insurmountable during even the history matching process where the DFN needs to be rebuilt for each updating of its characteristic parameters. History matching is a process by which an initial reservoir model is built, then its parameters (e.g. permeability and porosity) are adjusted and calibrated to historical production data so that the final model is able to reasonably reproduce, for example, well-flow-rates and pressure histories. In the case of a fractured subterranean reservoir, using an analytical proxy instead of an explicit discrete fracture network (DFN) model makes the history matching process much more efficient, again because building and modifying a DFN model is computation/human time consuming.

When fractures are interconnected or intersect, a dual media approach may be utilized for modeling fluid flow in fractured subterranean reservoirs. Such an approach involves superimposing two grids; a first grid representing fractures through a matrix, such as a particular type of rock, and a second grid representing the matrix, or rock, itself. The matrix grid is the main fluids stagnant domain, while the fracture grid is the main fluid flow domain. Coupling between the fracture and the matrix grids may be through a transfer function, called a shape factor. A shape factor may be calculated by representing the fracture network as three orthogonal fracture sets along the coordinate axes. This representation is generally not realistic. What is needed is an analytical method of calculating shape factors of fractured reservoir models that account for fracture spacing intensity and fracture set orientation, and that do not require building an explicit DFN.

### SUMMARY

A method of calculating a shape factor, such as a general shape factor or an overall shape factor, may include identifying a plurality of fracture sets within a subterranean formation, determining an orientation of each of the plurality of fracture sets, determining a fracture spacing intensity of each of the plurality of fracture sets, calculating an angle formed between each pair of the plurality of fracture sets, calculating a shape factor for each particular configuration of the plurality of fracture sets, and developing an ellipse-based equation utilizing the shape factor for each particular configuration of the plurality of fracture sets and the angles formed between the plurality of fracture sets. Calculating a shape factor for each particular configuration of the plurality of fracture sets may include calculating an individual and specific shape factor for a given fracture set that can be used in deriving or calculating a general shape factor using an equation (e.g. an ellipse based equation) to arrive at what is known as a general shape factor, an overall shape factor or an elliptical or ellipse-based equation shape factor. Thus, an overall shape factor for a geological formation may be calculated using, in part, individual shape factors for intersecting fracture sets of the geological formation. Calculation of an overall shape factor may speed the recovery of hydrocarbons by eliminating the time normally necessary to build an explicit discrete fracture network model. Thus, fracture property modeling and history matching processes are simplified, thereby reducing processing or calculation time of computer simulations of fluid flows of a given subterranean formation.

In accordance with the method of calculating a shape factor, identifying a plurality of fracture sets within a subterranean formation may further include identifying (from the plurality of fracture sets) a first fracture set, a second fracture set, and a third fracture set, that intersect each other. Determining an orientation of each of the plurality of fracture sets may further include determining an azimuth and a dip of a first fracture set, determining an azimuth and a dip of a second fracture set, and determining an azimuth and a dip of a third fracture set. The first fracture set, the second fracture set and the third fracture set are identified from the plurality of fracture sets. Determining a fracture spacing intensity of each of the plurality of fracture sets may further include determining a fracture spacing intensity of a first fracture set, determining a fracture spacing intensity of a second fracture set, and determining a fracture spacing intensity of a third fracture set.

In accordance with the method of calculating a shape factor, calculating an angle formed between each pair of the plurality of fracture sets may further include calculating a normal vector for each of the plurality of fracture sets, calculating a cosine of an angle between each pair of intersecting fracture sets, and calculating a sine of an angle between each pair of intersecting fracture sets. Calculating a shape factor for each particular configuration of the plurality of fracture sets may further include: calculating a first shape factor when a first fracture set, a second fracture set, and a third fracture set of the plurality of fracture sets are parallel to each other; calculating a second shape factor when the first fracture set and the second fracture set are parallel to each other, but the first fracture set and the second fracture set are orthogonal to the third fracture set; calculating a third shape factor when the first fracture set and the third fracture set are parallel to each other, but the first fracture set and the third fracture set are orthogonal to the second fracture set; calculating a fourth shape factor when the second fracture set and the third fracture set are parallel to each other, but the second fracture set and the third fracture set are orthogonal to the first fracture set; and calculating a fifth shape factor when the first fracture set, the second fracture set, and the third fracture set are orthogonal to each other.

Developing an ellipse-based equation utilizing shape factors and angles between each pair of the plurality of fracture sets may further include: developing an elliptic equation based on five different shape factors from three different fracture sets. The elliptic or ellipse-based equation, in one scenario, yields a shape factor for (i.e. based upon) two or three general fracture sets. In another scenario, the elliptic equation is based upon a two-dimensional ellipse for two general fracture sets. Still yet, the elliptic equation may be based upon a fifth order ellipsoid for three general fracture sets. The elliptic equation reproduces or utilizes the shape factor of each of five particular configurations of the plurality of fracture sets and yields a general shape factor for use with any geometric configuration of fracture sets. The general shape factor may be an approximation.

In another scenario, a method of calculating a shape factor, such as an overall or general shape factor for a plurality of fracture sets, may include: identifying a first fracture set, identifying a second fracture set and identifying a third fracture set within a subterranean formation; determining a first azimuth and a first dip of the first fracture set; determining a second azimuth and a second dip of the second fracture set; determining a third azimuth and a third dip of the third fracture set; determining a fracture spacing intensity of each fracture set of the plurality of fracture sets; measuring an angle formed by an intersection of the first and second fracture sets; measuring an angle formed by an intersection of the first and third fracture sets; measuring an angle formed by an intersection of the second and third fracture sets; calculating a shape factor for each fracture set of the plurality of fracture sets; and developing an ellipse-based equation utilizing the calculated shape factors and angles from the of the plurality of fracture sets. Determining may be calculating.

Continuing with the method, calculating cosines of angles between each of adjacent fracture sets may further include: calculating a cosine of the angle between a first fracture set and a second fracture set, calculating a cosine of the angle between a first fracture set and a third fracture set, and calculating a cosine of the angle between a second fracture set and a third fracture set. Moreover, as part of the method, calculating a sine of an angle between each of adjacent fracture sets may further include calculating a sine of the angle between the first fracture set and the second fracture set, calculating a sine of the angle between the first fracture set and the third fracture set, and calculating a sine of the angle between the second fracture set and the third fracture set. Calculating an angle formed between each pair of the plurality of fracture sets may include: calculating a normal vector for each of the plurality of fracture sets, calculating a cosine of an angle between each pair of intersecting fracture sets, and calculating a sine of an angle between each pair of intersecting fracture sets.

Calculating a shape factor for each fracture set of the plurality of fracture sets may further include: calculating a first shape factor when a first fracture set, a second fracture set, and a third fracture set are parallel to each other; calculating a second shape factor when a first fracture set and a second fracture set are parallel to each other, but the first fracture set and the second fracture set are orthogonal to a third fracture set; calculating a third shape factor when the first fracture set and the third fracture set are parallel to each other, but the first fracture set and the third fracture set are orthogonal to the second fracture set; calculating a fourth shape factor when the second fracture set and the third fracture set are parallel to each other, but the second fracture set and the third fracture set are orthogonal to the first fracture set; and calculating a fifth shape factor when the first fracture set, the second fracture set, and the third fracture set are orthogonal to each other. Developing an ellipse-based equation utilizing the shape factors and angles between each pair of the plurality of fracture sets further includes developing an elliptic or ellipse-based equation based on five different shape factors from three different fracture sets. The elliptic equation is based upon a fifth order ellipsoid. The elliptic equation reproduces or utilizes the shape factor of each of the five particular configurations of the plurality of fracture sets and yields a general shape factor for use with any geometric configuration of fracture sets. Thus, the method includes solving for a general shape factor different from those utilized elsewhere in the elliptic equation.

The ellipse-based equation may be utilized in a full-field dual media flow model, which may be displayed on a display screen for evaluation by a user.

### BRIEF DESCRIPTION OF THE DRAWINGS

A more complete understanding of the present invention and benefits thereof may be acquired by referring to the follow description taken in conjunction with the accompanying drawings in which:

FIG. 1 is a perspective view of a subterranean reservoir in accordance with the present teachings;

FIG. 2 is an enlarged view of an intersection of two fracture sets in accordance with the present teachings;

FIG. 3 is an elliptic form of a shape factor in accordance with the present teachings;

FIG. 4 is a graph of shape factor versus angle between two fracture sets in accordance with the present teachings; and

FIG. 5 is a depiction of azimuth and dip of a fracture plane in accordance with the present teachings.

### DETAILED DESCRIPTION

Turning now to the detailed description of the preferred arrangement or arrangements of the present disclosure, it should be understood that the inventive features and concepts may be manifested in other arrangements and that the scope of the disclosure is not limited to the embodiments described or illustrated.

Most subterranean hydrocarbon reservoirs have a matrix rock that is fractured in some way. When the fractures are interconnected, they form preferential flow paths between an injector well and a production well. Modeling of fluid flow through reservoirs with interconnected fractures is often based on the dual media (matrix and fracture) approach, in which the matrix medium is the main fluids stagnant domain, while the fracture medium is the main fluid flow domain. Coupling between the fracture and the matrix media may be through a transfer function, called a shape factor. Thus, a shape factor may be an approximation for flow between the matrix and fracture sets.

The shape factor of a dual media model characterizes fluid exchange between a fracture grid node and a matrix grid node for a given subterranean formation. For single phase fluid flow through a subterranean formation, the shape factor sigma, σ, may be defined by:

$${F}_{mf} = σ V \frac{K}{μ} ( {p}_{m} - {p}_{f} ) \qquad Equation ( 1 )$$

where:
F_{mf} is the volumetric flux of matrix-fracture exchange in cubic feet/second,
V is the volume of the flow simulation grid cell in cubic feet,
K is the matrix permeability in square feet,
μ is the fluid viscosity in pascal-second,
pₘ is the matrix pressure in pascals,
p_{f} is the fracture pressure in pascals, and
σ is the shape factor in per square feet (i.e. 1/square feet), which represents the geometric aspect of the transmissibility between the matrix grid and the fracture grid nodes per unit volume.

When the fracture network can be simplified to one, two or three regular and orthogonal fracture sets, which are commonly referred to as equivalent fracture sets, the matrix grid cell may be represented by an array of identical rectangular parallelepipeds, which are also known as matrix blocks. Based on Equation (1) and by integrating the matrix-fracture exchange flux of all matrix blocks in a grid cell, the shape factor (σ) may be expressed as in Equation (2).

$$σ = α {\sum }_{i = 1}^{{n}_{d}} 1 / {l}_{i}^{2} \qquad Equation ( 2 )$$

where:
n_{d} is a space dimension,
lᵢ is a matrix block size in dimension i (feet), and
α is a dimensionless “pre-factor” whose value depends upon an underlying assumption of fluid flow conditions, such as whether the type of fluid flow conditions are convection or diffusion, transient or steady state, etc.

Van Heel and Boerrigter (2006, SPE 102471) provide a review of the different pre-factor values proposed by various authors such as:

Kazemi et al. (1976): α=4 (quasi-steady state, convection-type flow),

Ueda et al. (1989), Coats (1989): α=8˜12 (quasi-steady state, diffusion-type flow), and

Chang (1993), Lim and Aziz (1995): α=π²≈10 (asymptotic value, transient diffusion-type flow).

Van Heel and Boerrigter (2006, SPE 102471) further recommends using a steady-state or transient diffusion-type pre-factor for diffusion-dominated recovery processes and the convection-type pre-factor for convection-dominated recovery processes. A discussion of how one determines a dominant recovery process is beyond the range of this disclosure.

Shape factor σ is actually not a purely geometrical parameter, but is composed of a “fluid dynamic factor,” which is pre-factor α, and a “geometrical factor,” which is

$${\sum }_{i = 1}^{{n}_{d}} 1 / {l}_{i}^{2} .$$

As discussed above, pre-factor α may be chosen according to the dominant recovery process of each specific subterranean reservoir, or calibrated through an inverse method in each case. For the present disclosure, and because of a relationship between a given subterranean fracture geometry and its shape factor, focus is centered on geometric

factor

$${\sum }_{i = 1}^{{n}_{d}} 1 / {l}_{i}^{2} ,$$

which is directly related to fracture set intensity and fracture set orientation. Fracture set intensity is the number of fractures per unit length along a subterranean sample line such as an injector well and a production well. Fracture set orientation refers to the azimuths and dips of groups or sets of more or less parallel fracture planes through a body of rock.

The present disclosure accounts for a shape factor in the case of one, two or three general fracture sets. Consider the case of a single fracture set with fracture spacing intensity d₁ defined by

$${d}_{1} = \frac{{n}_{1}}{{L}_{1}} = \frac{1}{{l}_{1}} .$$

where:
L₁ is a simulation grid cell size,
n₁ is the number of fractures in a simulation grid cell of size L₁.

The shape factor (σ) of Equation (2) with n_{d}=1 may be rewritten in terms of fracture spacing intensity d₁, and yields σ=αd₁².

A second fracture set may be added to the cell with a spacing intensity d₂. If the two fracture sets are orthogonal to each other, the shape factor of Equation (2), with n_{d}=2, may be rewritten in terms of spacing intensity d₁ and d₂, to arrive at σ_{+=α(d}ᵢ²+d₂²). The subscript “+” represents orthogonal fracture sets. However, if the above two fracture sets become parallel, they can be considered a single fracture set, but with a spacing intensity equal to d₁+d₂. This leads to a shape factor of σ₌=α(d₁+d₂)² in which subscript “=” represents parallel fracture sets.

Thus, the shape factor σ is systematically larger when two fracture sets are parallel than when they are orthogonal. For instance, when d₁=d₂, the shape factor with parallel fracture sets may be mathematically twice or double the shape factor computed with orthogonal fracture sets.

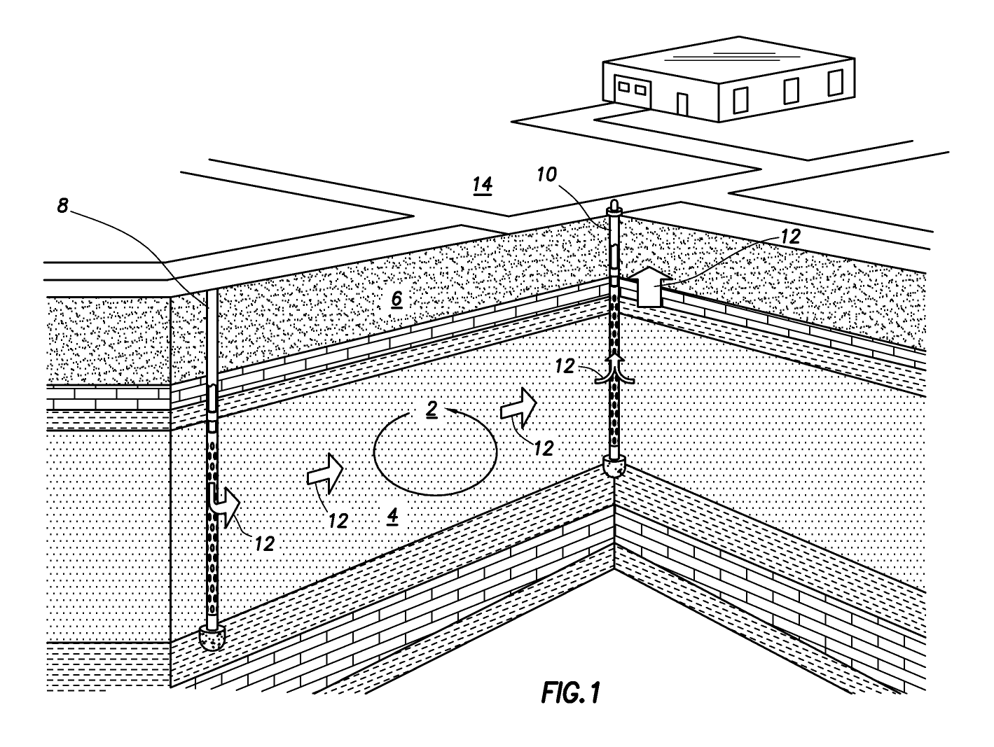

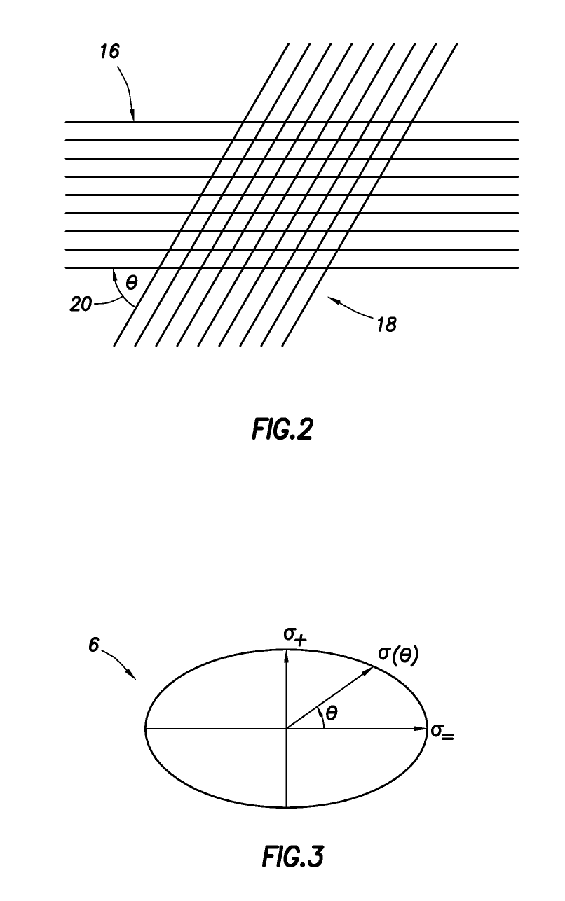

On the basis of the above, FIG. 1 depicts a subterranean oil reservoir 2, which may possess fracture sets in a matrix 4 below an earthen overburden 6. Subterranean oil reservoir 2 and matrix 4 may be located between an injector well 8 and a production well 10. Arrows 12 generally indicate directional flow of oil from injector well 8 to production well 10 and to earthen surface 14 during extraction of oil from subterranean reservoir 2. As an example, and with reference to FIG. 2, a first fracture set 16 and a second fracture set 18 may intersect to form an angle theta, θ, indicated with reference numeral 20.

While FIG. 1 depicts where fracture sets may occur and FIG. 2 depicts how fracture sets of a subterranean formation may intersect in a subterranean reservoir 2, FIG. 3 depicts an ellipse 6, which provides a basis for formation of mathematical equations of the present disclosure. Thus, as depicted, angle θ forms an angle between two fracture sets, and shape factor σ then may be computed using an elliptic equation as a basis. Equation 3 and Equation 4 are elliptical forms of a shape factor based upon angle theta, θ, of FIGS. 2 and 3.

$$\begin{matrix}\frac{{σ}^{2} ( θ ) {cos}^{2} θ}{{σ}_{=}^{2}} + \frac{{σ}^{2} ( θ ) {sin}^{2} θ}{{σ}_{+}^{2}} = 1 \\ or , & ( Equation 3 ) \\ \frac{1}{{σ}^{2} ( θ )} = \frac{{cos}^{2} θ}{{σ}_{=}^{2}} + \frac{{sin}^{2} θ}{{σ}_{+}^{2}} & ( Equation 4 )\end{matrix}$$

To confirm that shape factors may be expressed in elliptical form in accordance with FIG. 3, knowing that if) σ(0°)=σ(90°)=σ(180°)=σ(270°), one can reasonably accept that σ(θ) may be expressed as a circle because it is the simplest differentiable curve satisfying σ(0°)=σ(90°)=σ(180°)=σ(270°). Similarly, if σ(0°)=σ(180°)≠σ(90°)=σ(270°), one can reasonably infer that σ(θ) is an ellipse because it is the simplest differentiable curve satisfying) σ(0°)=σ(180°)≠σ(90°)=(270°).

In terms of fracture set intensity d₁, d₂ and angle θ, which may be an acute or obtuse angle formed at an intersection of different fracture sets, Equation 5 as recited below may be computed.

$$σ ( θ ) = {α [ \frac{{cos}^{2} θ}{{( {d}_{1} + {d}_{2} )}^{4}} + \frac{{sin}^{2} θ}{{( {d}_{1}^{2} + {d}_{2}^{2} )}^{2}} ]}^{- \frac{1}{2}} \qquad ( Equation 5 )$$

From a practical perspective, orientation of a fracture set may be defined by its azimuth and dip. In the art of subterranean exploration for oil and natural gas, azimuth may be considered a compass orientation, and dip may be considered a direction and vertical angle of a given plane. Azimuth and dip for a given fracture plane may be visualized as depicted in FIG. 5. More specifically, FIG. 5 depicts fracture 20, which may be a fracture plane, rotated from a horizontal plane 22 at an angle 24, which may be a dip and represented by ω. Fracture 20 may then be rotated or tilted at an angle 26, which may be an azimuth and represented by α.

Given azimuth α₁ and dip ω₁ for fracture set 1, and azimuth α₂ and dip ω₂ for fracture set 2, one may compute:
The normal vector for fracture set 1:

n¹=(nᵢ¹, nⱼ¹, nₖ¹)=(sin α₁ sin ω₁, cos α₁ sin ω₁, cos ω₁) (Equation 6)
The normal vector for fracture set 2:

n²=(nᵢ², nⱼ², nₖ²)=(sin α₂ sin ω₂, cos α₂ sin ω₂, cos ω₂) (Equation 7)
and the cosine of an angle between the two fracture sets:

cos θ= [symbol] n¹, n ² [symbol] =sin α₁ sin ω₁ sin α₂ sin ω₂+cos α₁ sin ω₁ cos α₂ sin ω₂+cos ω₁ cos ω₂ (Equation 8)

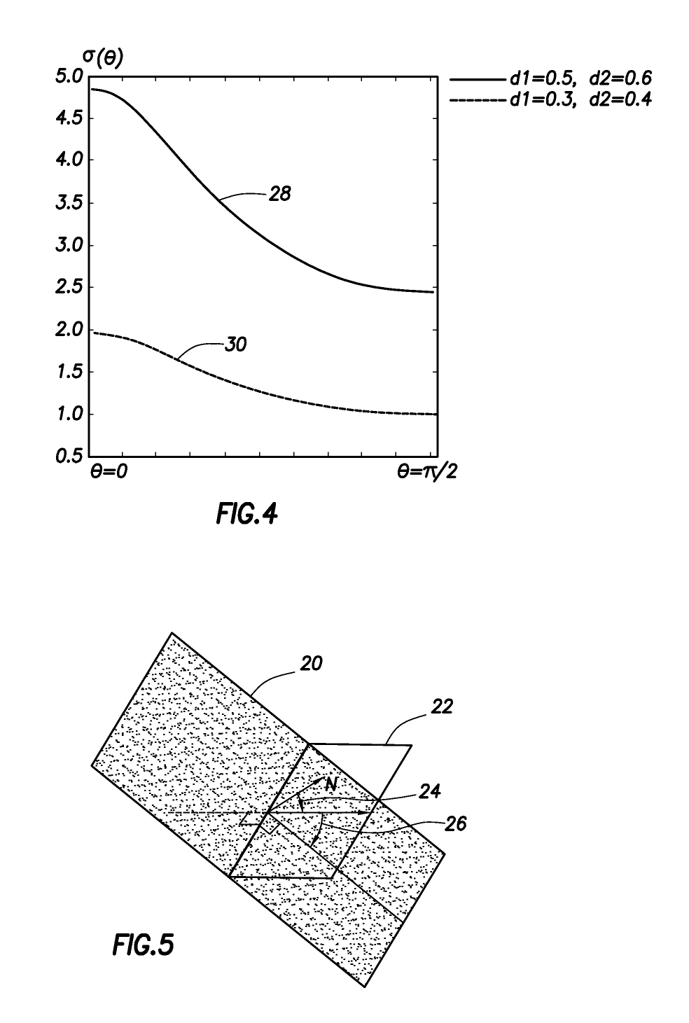

Thus, shape factors may be calculated and plotted. FIG. 4 graphically depicts Equation 5 in two different cases, each case having a different fracture spacing intensity value. More specifically, plot 28 and plot 30 of FIG. 4 depict shape factor sigma σ(θ) as a function of angle theta θ between two different fracture sets of intensities d₁ and d₂, as indicated, using α=4, which is a predetermined pre-factor as proposed by Kazemi et al., as previously discussed. From FIG. 4, first plot 28 and second plot 30 depict how shape factors change with respect to the angle between two fracture sets. Also evident from plots 28 and 30, shape factor σ may be reduced by about half from θ=0 to θ=0.5π.

A shape factor may also be calculated in the case of three general fracture sets, which may be defined as follows:
Fracture Set 1 with Azimuth α₁ and Dip ω₁ having a normal vector:

n¹=(nᵢ¹, nⱼ¹, nₖ¹)=(sin α₁ sin ω₁, cos α₁ sin ω₁, cos ω₁) (Equation 9)

Fracture Set 2 with Azimuth α₂ and Dip ω₂ having a normal vector:

n²=(nᵢ², nⱼ², nₖ²)=(sin α₂ sin ω₂, cos α₂ sin ω₂, cos ω₂) (Equation 10)

Fracture Set 3 with Azimuth α³ and Dip ω₃ having a normal vector:

n³=(nᵢ³, nⱼ³, nₖ³)=(sin α₃ sin ω₃, cos α₃ sin ω₃, cos ω₃) (Equation 11)

In a case where θ₁₂ is an angle between fracture set 1 and 2, θ₂₃, is an angle between fracture set 2 and 3, and θ₁₃ is an angle between fracture set 1 and 3, respectively, the cosine and sine of each angle between each respective fracture set may be expressed as:

cos θ₁₂= [symbol] n¹, n² [symbol] =sin α₁ sin ω₁ sin α₂ sin ω₂+cos α₁ sin ω₁ cos α₂ sin ω₂+cos ω₁ cos ω₂ (Equation 12)

cos θ₁₃= [symbol] n¹, n³)=sin α₁ sin ω₁ sin α₃ sin ω₃+cos α₁ sin ω₁ cos α₃ sin ω₃+cos ω₁ cos ω₃ (Equation 13)

cos θ₂₃= [symbol] n², n³)=sin α₂ sin ω₂ sin α₃ sin ω₃+cos α₂ sin ω₂ cos α₃ sin ω₃+cos ω₂ cos ω₃ (Equation 14)

sin² θ₁₂=1−cos² θ₁₂ (Equation 15)

sin²θ₁₃=1−cos ² θ₁₃ (Equation 16)

sin²θ₂₃=1−cos² θ₂₃ (Equation 17)

Fracture spacing intensity is generally noted in terms of number of fractures per unit length along a particular line such as a subterranean borehole. Thus, if d₁, d₂ and d₃ are fracture spacing intensities of fracture sets 1, 2 and 3, respectively, the following shape factors may be calculated as expressed in Equation (18) through Equation (22), which are the only five cases where one can derive shape factor as a function of fracture spacing intensities of the three fracture sets.
Case (1) in which θ₁₂=θ₂₃=θ₁₃=0° represents three parallel fracture sets:

σ₁=α(d₁+d₂+d₃)² (Equation 18)
Case (2) in which θ₁₂=0° and θ₂₃=θ₁₃=90° represents a scenario in which fracture sets 1 and 2 are parallel to each other, and together fracture sets 1 and 2 are orthogonal to fracture set 3:

σ₂=α(d₁+d₂+d₃)² (Equation 19)
Case (3) in which θ₁₃=0° and θ₁₂=θ₂₃=90° represents a scenario in which fracture sets 1 and 3 are parallel to each other, and together fracture sets 1 and 3 are orthogonal to fracture set 2:

σ₃=α(d₁+d₃)²+αd₂² (Equation 20)
Case (4) in which θ₂₃=0° and θ₁₂=19₁₃=90°, represents a scenario in which fracture sets 2 and 3 are parallel to each other, and together fracture sets 2 and 3 are orthogonal to fracture set 1:

σ₄=αd₁²+α(d₂+d₃)² (Equation 21)
Case (5) in which θ₁₂=θ₂₃=θ₁₃=90° represents three orthogonal fracture sets:

σ₅=α(d₁²+d₂²+d₃²) (Equation 22)

The elliptic equation explained above in the case of two fracture sets may be extended to the case of three fracture sets as follows:

$$\frac{1}{{σ}^{2} ( {θ}_{12 ,} {θ}_{23 ,} , {θ}_{13 ,} )} = \frac{cos {θ}_{12} cos {θ}_{23} cos {θ}_{13}}{{σ}_{1}^{2}} + \frac{cos {θ}_{12} sin {θ}_{23} sin {θ}_{13}}{{σ}_{2}^{2}} + \frac{sin {θ}_{12} sin {θ}_{23} cos {θ}_{13}}{{σ}_{3}^{2}} + \frac{sin {θ}_{12} cos {θ}_{23} sin {θ}_{13}}{{σ}_{4}^{2}} + \frac{sin {θ}_{12} sin {θ}_{23} sin {θ}_{13}}{{σ}_{5}^{2}} \qquad ( Equation 23 )$$

Validation of Equation (23) confirms that it satisfies the following five analytically calculable cases.
Case (1) in which θ₁₂=θ₂₃=θ₁₃=0°. Using these values in Equation 23 yields σ(θ_{12,}θ_{23,},θ_{13,})=σ₁,
Case (2) in which θ₁₂=0° and θ₂₃=θ₁₃=90°. Using these values in Equation 23 yields σ(θ_{12,}θ_{23,},θ_{13,})=σ₂,
Case (3) in which θ₁₃=0° and θ₁₂=θ₂₃=90°. Using these values in Equation 23 yields σ(θ₁₂,θ_{23,},θ_{13,})=σ₃,
Case (4) in which θ₂₃=0° and θ₁₂=θ₁₃=90°. Using these values in Equation 23 yields σ(θ_{12,},θ_{23,},θ₁₃,)=σ₄ , and
Case (5) in which θ₁₂=θ₂₃=θ₁₃=90°. Using these values in Equation 23 yields σ(θ_{12,}θ_{23,},θ_{13,})=σ₅

Equation (23) satisfies also three equivalent cases of two fracture sets, each case relating to parallel fracture sets.
In case (6), θ₁₂=0°, meaning that fracture sets 1 and 2 are parallel to each other; thus,

$${θ}_{23} = {θ}_{13} and \\ \frac{1}{{σ}^{2} ( {θ}_{12 ,} {θ}_{23 ,} , {θ}_{13 ,} )} = \frac{{cos}^{2} {θ}_{23}}{{σ}_{1}^{2}} + \frac{{sin}^{2} {θ}_{23}}{{σ}_{2}^{2}} . \qquad ( Equation 24 )$$

In case (7), θ₁₃=0°, meaning that fracture sets 1 and 3 are parallel to each other; thus,

$${θ}_{12} = {θ}_{23} and \\ \frac{1}{{σ}^{2} ( {θ}_{12 ,} {θ}_{23 ,} , {θ}_{13 ,} )} = \frac{{cos}^{2} {θ}_{12}}{{σ}_{1}^{2}} + \frac{{sin}^{2} {θ}_{12}}{{σ}_{3}^{2}} . \qquad ( Equation 25 )$$

In case (8), θ₂₃=0°, meaning that fracture sets 2 and 3 are parallel to each other; thus,

$${θ}_{12} = {θ}_{13} and \\ \frac{1}{{σ}^{2} ( {θ}_{12 ,} {θ}_{23 ,} , {θ}_{13 ,} )} = \frac{{cos}^{2} {θ}_{12}}{{σ}_{1}^{2}} + \frac{{sin}^{2} {θ}_{12}}{{σ}_{4}^{2}} . \qquad ( Equation 26 )$$

In addition to cases (1)-(8) above, which pertain to particular orientations of fracture sets, Equation 23 may mathematically encompass or account for most real world scenarios of fracture sets in subterranean reservoirs. Thus, the elliptic equation reproduces or utilizes the shape factor of each of five particular configurations of the plurality of fracture sets to arrive at or yield a general shape factor for use with any geometric configuration of fracture sets.

Uncertainties pertaining to intensities and orientations of fracture sets may be accounted for by randomizing such parameters directly in Equations (3) and (23), or by using them as parameters during a subsequent history matching process. The uncertainty of a parameter can be represented by a random variable defined by a probability distribution. Thus, more accurate adjustment of a model of a reservoir until it closely reproduces past reservoir behavior is possible. Once a model has been history matched, it can be used to simulate future reservoir behavior with a higher degree of confidence, particularly if the adjustments are constrained by known geological properties or geological structures in the reservoir. Higher degrees of confidence related to reservoir behavior (e.g. fluid flow through fracture sets of a subterranean formation or reservoir) are attained through calculation of a general shape factor based upon an elliptic equation. Moreover, the time expended compared to traditional history matching routines is reduced and the fracture property modeling is simplified. Thus, modeling fluid flow in fractured reservoirs may be accomplished more quickly, thereby saving time and reducing costs historically associated with fluid modeling fractured reservoirs that utilize discrete fracture networks that are subsequently converted to equivalent fracture grid properties using an upscaling procedure. Evaluation of fluid flow in a subterranean formation is thus more quickly predicted and viewed on a computer screen. The method may be considered as a method of reducing time to model fluid flows for recovery of hydrocarbons by calculating an overall shape factor.

In closing, it should be noted that the discussion of any reference is not an admission that it is prior art to the present invention, especially any reference that may have a publication date after the priority date of this application. At the same time, each and every claim below is hereby incorporated into this detailed description or specification as an additional embodiment of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A method of calculating an overall shape factor comprising:
identifying a plurality of fracture sets within a subterranean formation;
determining an orientation of each of the plurality of fracture sets;
determining a fracture spacing intensity of each of the plurality of fracture sets;
calculating an angle formed between each pair of the plurality of fracture sets;
calculating a shape factor for each particular configuration of the plurality of fracture sets; and
developing an ellipse-based equation utilizing the shape factor for each particular configuration of the plurality of fracture sets and the angles formed between the plurality of fracture sets.

2. The method of calculating a shape factor according to claim 1, wherein identifying a plurality of fracture sets within a subterranean formation further comprises:
identifying a first fracture set, a second fracture set, and a third fracture set, that intersect each other from the plurality of fracture sets.

3. The method of calculating a shape factor according to claim 1, wherein determining an orientation of each of the plurality of fracture sets further comprises:
determining an azimuth and a dip of a first fracture set;
determining an azimuth and a dip of a second fracture set; and
determining an azimuth and a dip of a third fracture set, wherein the first fracture set, the second fracture set and the third fracture set are identified from the plurality of fracture sets.

4. The method of calculating an overall shape factor according to claim 1, wherein determining a fracture spacing intensity of each of the plurality of fracture sets further comprises:
determining a fracture spacing intensity of a first fracture set;
determining a fracture spacing intensity of a second fracture set; and
determining a fracture spacing intensity of a third fracture set, wherein the first fracture set, the second fracture set and the third fracture set are identified from the plurality of fracture sets.

5. The method of calculating an overall shape factor according to claim 1, wherein calculating an angle formed between each pair of the plurality of fracture sets further comprises:
calculating a normal vector for each of the plurality of fracture sets;
calculating a cosine of an angle between each pair of intersecting fracture sets; and
calculating a sine of an angle between each pair of intersecting fracture sets.

6. The method of calculating an overall shape factor according to claim 1, wherein calculating a shape factor for each particular configuration of the plurality of fracture sets further comprises:
calculating a first shape factor when a first fracture set, a second fracture set, and a third fracture set of the plurality of fracture sets are parallel to each other;
calculating a second shape factor when the first fracture set and the second fracture set are parallel to each other, but the first fracture set and the second fracture set are orthogonal to the third fracture set;
calculating a third shape factor when the first fracture set and the third fracture set are parallel to each other, but the first fracture set and the third fracture set are orthogonal to the second fracture set;
calculating a fourth shape factor when the second fracture set and the third fracture set are parallel to each other, but the second fracture set and the third fracture set are orthogonal to the first fracture set; and
calculating a fifth shape factor when the first fracture set, the second fracture set, and the third fracture set are orthogonal to each other.

7. The method of calculating an overall shape factor according to claim 1, wherein developing an ellipse-based equation utilizing the above shape factors and angles between each pair of the plurality of fracture sets further comprises:
developing an elliptic equation based on five different shape factors from three different fracture sets.

8. The method of calculating an overall shape factor according to claim 7, wherein the elliptic equation yields a shape factor for two or three general fracture sets.

9. The method of calculating an overall shape factor according to claim 7, wherein the elliptic equation is based upon a two dimensional ellipse for two general fracture sets.

10. The method of calculating an overall shape factor according to claim 7, wherein the elliptic equation is based upon a fifth order ellipsoid for three general fracture sets.

11. The method of calculating an overall shape factor according to claim 7, wherein the elliptic equation reproduces the shape factor of each of the five particular configurations of the plurality of fracture sets.

12. A method of calculating an overall shape factor comprising:
identifying a first fracture set, a second fracture set and a third fracture set within a subterranean formation;
determining a first azimuth and a first dip of the first fracture set;
determining a second azimuth and a second dip of the second fracture set;
determining a third azimuth and a third dip of the third fracture set;
determining a fracture spacing intensity of each fracture set of the plurality of fracture sets;
measuring an angle formed by an intersection of the first and second fracture set;
measuring an angle formed by an intersection of the first and third fracture set;
measuring an angle formed by an intersection of the second and third fracture set;
calculating a plurality of shape factors, wherein one shape factor is calculated for each fracture set of the plurality of fracture sets; and
developing an ellipse-based equation utilizing the plurality of shape factors and angles from the each of the plurality of fracture sets.

13. The method of calculating an overall shape factor according to claim 12, wherein calculating cosines of angles between each of adjacent fracture sets further comprises:
calculating a cosine of the angle between a first fracture set and a second fracture set,
calculating a cosine of the angle between a first fracture set and a third fracture set, and
calculating a cosine of the angle between a second fracture set and a third fracture set.

14. The method of calculating an overall shape factor according to claim 13, wherein calculating a sine of an angle between each of adjacent fracture sets further comprises:
calculating a sine of the angle between the first fracture set and the second fracture set,
calculating a sine of the angle between the first fracture set and the third fracture set, and
calculating a sine of the angle between the second fracture set and the third fracture set.

15. The method of calculating an overall shape factor according to claim 14, wherein calculating an angle formed between each pair of the plurality of fracture sets further comprises:
calculating a normal vector for each of the plurality of fracture sets;
calculating a cosine of an angle between each pair of intersecting fracture sets; and
calculating a sine of an angle between each pair of intersecting fracture sets.

16. The method of calculating an overall shape factor according to claim 15, wherein calculating a shape factor for each fracture set of the plurality of fracture sets further comprises:
calculating a first shape factor when a first fracture set, a second fracture set, and a third fracture set are parallel to each other;
calculating a second shape factor when a first fracture set and a second fracture set are parallel to each other, but the first fracture set and the second fracture set are orthogonal to a third fracture set;
calculating a third shape factor when the first fracture set and the third fracture set are parallel to each other, but the first fracture set and the third fracture set are orthogonal to the second fracture set;
calculating a fourth shape factor when the second fracture set and the third fracture set are parallel to each other, but the second fracture set and the third fracture set are orthogonal to the first fracture set; and
calculating a fifth shape factor when the first fracture set, the second fracture set, and the third fracture set are orthogonal to each other.

17. The method of calculating an overall shape factor according to claim 16, wherein developing an ellipse-based equation utilizing the shape factors and angles between each pair of the plurality of fracture sets further comprises:
developing an elliptic equation based on five different shape factors from three different fracture sets.

18. The method of calculating an overall shape factor according to claim 17, wherein the elliptic equation is based upon a fifth order ellipsoid.

19. A method of reducing time to model fluid flows for recovery of hydrocarbons by calculating an overall shape factor, the method comprising:
identifying a first fracture set, a second fracture set and a third fracture set within a subterranean formation;
determining a first azimuth and a first dip of the first fracture set;
determining a second azimuth and a second dip of the second fracture set;
determining a third azimuth and a third dip of the third fracture set;
determining a fracture spacing intensity of each fracture set of the plurality of fracture sets;
measuring an angle formed by an intersection of the first and second fracture set;
measuring an angle formed by an intersection of the first and third fracture set;
measuring an angle formed by an intersection of the second and third fracture set;
calculating a plurality of shape factors, wherein one shape factor is calculated for each fracture set of the plurality of fracture sets;
developing an ellipse-based equation utilizing the plurality of shape factors and angles from the each of the plurality of fracture sets;
utilizing the ellipse-based equation in a full-field dual media flow model; and
displaying the full-field dual media flow model on a display screen.
